(19) United States
(12) Patent Application Publication
(10) Pub. No.: US 2004/0158553 A1
(43) Pub. Date: Aug. 12, 2004

(54) Method of using a smart device with a separate generic interface application

(75) Inventor: Jesse Peter Keller, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: ISE Research Corporation

(21) Appl. No.: 10/359,916

(22) Filed: Feb. 7, 2003

(51) Int. Cl. G06F 17/30

(52) U.S. Cl. 707/3

(57) ABSTRACT

A method of using a smart device includes providing a smart device including a microprocessor and a database, the database including one or more electronic description files including information about the smart device; providing a generic interface software application usable with different smart devices; configuring the generic interface software application to work specifically with the smart device using the information about the smart device from the database of the smart device; and interacting with the smart device using the interface software application configured to work specifically with the smart device.

### FIELD OF THE INVENTION

The field of the invention relates, in general, to systems and methods for interfacing microprocessor-based devices to other microprocessor-based display devices in a self-configuring and seamless manner.

### BACKGROUND OF THE INVENTION

The industrial and automotive fields are becoming dominated by so-called “smart devices.” Smart devices contain small microprocessors that perform a wide variety of functions. These functions may range from simple input/output control to complete automotive engine control. As companies develop smart devices, there is a need to configure and diagnose these smart devices after they are released to the customer. The accepted way to accomplish this task is by delivering with the smart device a piece of interface software that can be run on a personal computer. The smart device is attached to the personal computer via an electronic data link, and the interface software is run on the personal computer. The interface software presents the customer with a list of configuration options or a report of any problems with the smart device.

With new versions of the smart device, it becomes necessary for the smart device provider to update the interface software. New interface software may or may not be compatible with older versions of the smart device, increasing the difficulty of maintaining interface software and smart device compatibility. As the pace of new smart device development increases, the task of developing the associated interface software becomes a larger percentage of the smart device provider's project budget. Smart device providers may even have to hire additional personnel outside their core competencies to maintain the compatibility of the interface software with the smart devices.

If the interface software is not kept current with the smart devices, the interface software may become a limiting factor in delivery or customer acceptance of the smart device.

There is an additional need to control access to the features of the smart devices. The end user may be allowed to change some features of the smart device's performance, but not other features that may be deemed proprietary or too dangerous to release control. This requirement makes the development of the interface software even more expensive.

### SUMMARY OF THE INVENTION

An aspect of the invention involves a method of using a smart device including providing a smart device having a microprocessor and a database, the database including one or more electronic description files including information about the smart device; providing a generic interface software application usable with different smart devices; configuring the generic interface software application to work specifically with the smart device using the information about the smart device from the database of the smart device; and interacting with the smart device using the interface software application configured to work specifically with the smart device.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 is a schematic of an embodiment of a smart device in communication with a generic interface software application via a communications link.

FIG. 2 is a schematic of an embodiment of a smart device database including an electronic description file.

FIG. 3 is a flow chart illustrating an exemplary process for profiling a smart device.

FIG. 4 is a flow chart illustrating an exemplary process for obtaining a profile from the smart device with the generic interface software application.

FIG. 5 is a flow chart illustrating an exemplary process for customizing the smart device.

### DETAILED DESCRIPTION OF PREFERRED EMBODIMENTS

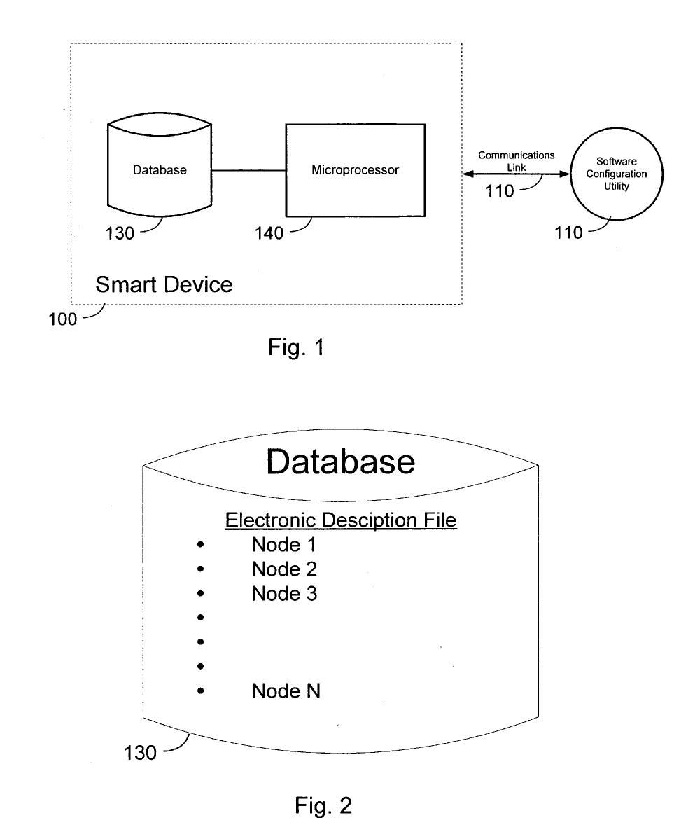

With reference to FIG. 1, an embodiment of a smart device 100 that may include on-board information for later configuring a generic interface software application 110 will now be described. All the information required to configure the generic interface software application 110 is stored on-board the smart device 100, eliminating the need for the developer of user interface software for the smart device 100 to keep track of the smart device configuration. The smart device 100 is in communication with the generic interface software application 110 via a communications link 120. Examples of smart devices 100 include, but not by way of limitation, vehicle components (i.e. engine controllers or anti-lock braking systems), manufacturing automation devices (i.e. lathes or milling machines), home appliances (i.e. clothes washers or air conditioning units), and medical equipment (i.e. diagnostics scanners or portable defibrillation machines).

The smart device 100 may include, among other elements, a database 130 coupled to a microprocessor 140. The database 130 may include one or more stored electronic description files or pre-generated data blocks. The electronic description file contains all the information required by the generic interface software application 110 to communicate with the smart device 100. The electronic description file may be written in a standard machine-to-machine communication language, preferably an Internet-compatible machine-to-machine communication language (i.e. XML or HTML) enabling third parties (other smart devices or software applications) to communicate with the smart device independent of the revision of the smart device.

With reference to FIG. 2, the information in the one or more stored electronic description files in the database 130 may be organized in one or more nodes, each node corresponding to a particular aspect, control data, or monitoring data of the smart device. For example, but not by way of limitation, a Node 1 may correspond to a sensor (e.g., temperature reading, pressure, voltage, processor workload) of the smart device 100, a Node 2 may correspond to an affecter (e.g., relay, indicator, software subroutine) of the smart device 100, a Node 3 may correspond to a static reference material (e.g., model number, photograph), and a Node N may include security information such as instructions on who can access the information and under what conditions. Each node may also include node information such as, but not limited to, one or more of the following: the name of the node in any number of languages, a unique canonical node identifier number or network address, the units of measurement that the node represents, detailed textual descriptions, size of the data generated by the node, and the rate of information generated by the node. One or more of the nodes may include static information about the smart device 100.

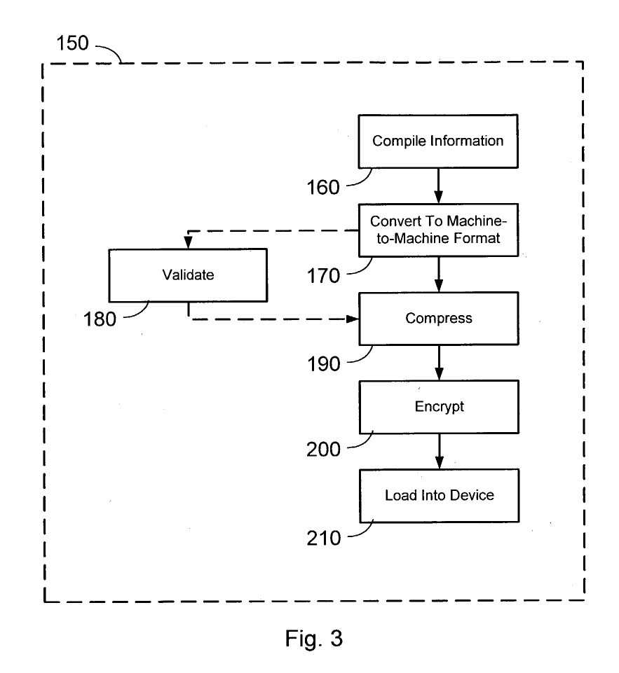

With reference to FIG. 3, a process 150 for profiling the smart device 100 with one or more electronic description files will now be described.

At a step 160, the data representing one or more electronic description files is compiled. This data can be static data manually generated by the smart device developer or automatically generated from source code for running the smart device 100. In the case of using source code to generate the data, software may be utilized during the source code compilation process to extract the data directly from the source code or from specially formatted annotations in the code listings. In the case of using static data, the data must be reformatted into a consistent, platform-independent form. The data may then be combined and imported into a central database where the electronic description file resides in a native format. The central database should contain all relevant, up-to-date information about the smart device 100 and its capabilities, configuration, and methods of access. The information in the central database may also be translated into different languages to support international use.

In a step 170, the one or more electronic description files in a native format are converted to a machine-to-machine format file. This format is exactly specified. In an optional step 180, the machine-to-machine format file may be validated to guarantee that the file meets the format specification. The standard machine-to-machine communication language enables third parties (e.g., other “smart” devices or software packages) to communicate with the smart device 100 independent of the revision of the smart device 100.

In a step 190, the one or more electronic description files may be electronically compressed to reduce their size. This should be a “lossless” compression scheme in that only redundant information is removed from the file, and should be completely reversible. A compressed version of the one or more electronic description files allows the smart device 100 to store proportionately more information about itself, allowing the user even more control over the smart device 100 through the generic interface software application 110.

In a step 200, the one or more electronic description files may be encrypted to prevent the distribution of sensitive information. The encrypted version may be unreadable by unauthorized parties, even if the smart device, the data transmission, or the generic interface software application 110 is compromised. The generation of an encrypted version ensures only authorized users have control of the smart device 100.

As an alternate embodiment, after step 170, the one or more electronic description files in machine-to-machine format may be divided into multiple files organized by information sensitivity, then compressed 190 and encrypted 200 separately. With the alternate embodiment, when at least one secret is compromised, the user may not have control over the whole smart device 100

In step 210, the one or more electronic description files are loaded or programmed into the smart device 100. This programming step can occur at the same time as the source code software is loaded into the smart device 100. By synchronizing these steps, it can be guaranteed that the one or more electronic description files in a machine-to-machine format correspond to the exact revision of the source code software. The loading step 210 may occur at the time of manufacture of the smart device 100. Alternatively, the loading step 210 may take place after delivery, after the smart device 100 is placed in service, for example, if the electronic description file needs to be modified. The loading step 210 may or may not take place over the same communications link or channel that the smart device 100 uses to communicate during operation. The programming step 210 may also be performed through the Internet.

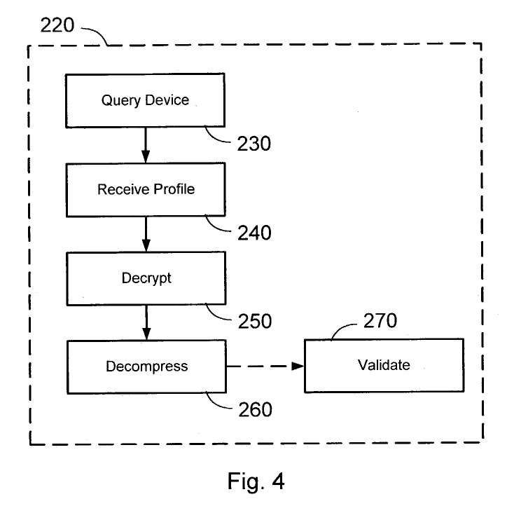

With reference to FIG. 4, a process 220 of obtaining a profile from the smart device 100 (i.e., transferring or retrieving the one or more electronic description files from the smart device 100 to the generic interface software application 110) will now be described. At some point, the generic interface software application 110 learns the capabilities of the smart device 100. Because the one or more electronic description files contain all the necessary information about the smart device 100, the use of these files is hardware independent.

In step 230, the generic interface software application 110 queries the smart device 100, requesting that the smart device 100 send the encrypted version of the one or more electronic description files across a communications link (e.g., serial data cable, low-speed serial links, industrial networks, wireless telephones, Internet). Because the one or more electronic description files are encrypted and stored in a platform independent format, there is no requirement for the communications link to be secure or specially configured.

In step 240, the generic interface software application 110 receives the one or more encrypted electronic description files from the smart device 100.

In step 250, the data block representing one or more electronic description files is decrypted.

In step 260, the generic interface software application 110 decompresses or decodes the compressed version of the one or more electronic description files to generate a raw, uncompressed version. The uncompressed version should be identical to the one or more electronic description files in a machine-to-machine format produced after step 170 described above, and, in an optional step 270, may be validated to ensure that the information has not become corrupted.

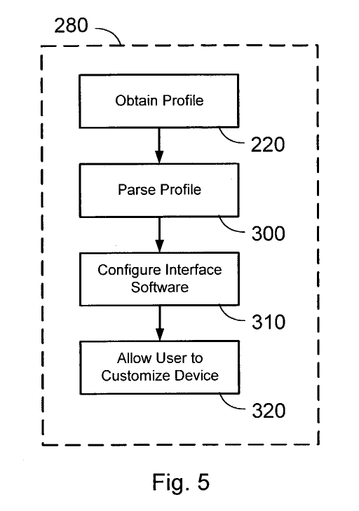

With reference to FIG. 5, a process 280 for customizing the smart device 100 using the generic interface software application 110 will be described.

In step 220, as described above, a profile (i.e., a machine-to-machine language version of the one or more electronic description files) from the smart device 100 is obtained by the generic interface software application 110.

In step 300, the machine-to-machine language version of the one or more electronic description files is then parsed by the generic interface software application 110 and kept in an internal information database. The generic interface software application 110 retrieves all the information it needs to present the user with a functional and accurate interface to the smart device 100.

In step 310, the generic interface software application 110 is configured using the information from the one or more electronic description files in the internal information database to present the user with a functional and accurate interface to the smart device 100 for controlling or configuring the smart device 100. The generic interface software application 110 may use the node name or a canonical identifier number to retrieve the real-time contents of the node or manipulate node values on-board the smart device 100.

In step 320, the user customizes the smart device 100, controls the smart device 100, performs diagnostics on the smart device 100, or performs one or more other actions on the smart device 100 using the configured generic interface software application 110.

In an alternative embodiment, the generic interface software application 110 may store the one or more electronic description files and only query the smart device 100 to check for modifications. This may be useful when the communications link is especially slow or expensive (e.g. wireless telephones, satellite data links).

It will be readily apparent to those skilled in the art that still further changes and modifications in the actual concepts described herein can readily be made without departing from the spirit and scope of the invention as defined by the following claims.

What is claimed is:

1. A method of using a smart device, the method including:
providing a smart device including a microprocessor and a database, the database including one or more electronic description files including information about the smart device;
providing a generic interface software application usable with different smart devices;
configuring the generic interface software application to work specifically with the smart device using the information about the smart device from the database of the smart device;
interacting with the smart device using the interface software application configured to work specifically with the smart device.

2. The method of claim 1, wherein providing a smart device includes profiling the smart device with one or more electronic description files.

3. The method of claim 2, wherein profiling the smart device includes compiling one or more electronic description files in a native format at least one of manually and automatically.

4. The method of claim 3, wherein profiling the smart device includes compiling one or more electronic description files automatically from source code for the smart device.

5. The method of claim 4, further including converting the one or more electronic description files in a native format to one or more electronic description files in a machine-to-machine format.

6. The method of claim 5, further including compressing the one or more electronic description files in a machine-to-machine format.

7. The method of claim 6, further including encrypting the one or more compressed electronic description files in a machine-to-machine format.

8. The method of claim 7, further including loading the one or more compressed, encrypted electronic description files in a machine-to-machine format into the database of the smart device.

9. The method of claim 8, wherein configuring the generic interface software application includes querying the smart device for and receiving the one or more compressed, encrypted electronic description files in a machine-to-machine format.

10. The method of claim 9, further including decrypting the one or more compressed, encrypted electronic description files in a machine-to-machine format.

11. The method of claim 10, further including decompressing the one or more compressed, decrypted electronic description files in a machine-to-machine format.

12. The method of claim 11, further including using information from the one or more decompressed, decrypted electronic description files to configure the generic interface software application to work specifically with the smart device.

13. The method of claim 1, wherein interacting with the smart device using the interface software application configured to work specifically with the smart device includes customizing the smart device with the configured interface software application.

14. The method of claim 1, wherein interacting with the smart device using the interface software application configured to work specifically with the smart device includes controlling the smart device with the configured interface software application.

15. The method of claim 1, wherein interacting with the smart device using the interface software application configured to work specifically with the smart device includes performing diagnostics on the smart device with the configured interface software application.

16. The method of claim 1, wherein interacting with the smart device using the interface software application configured to work specifically with the smart device includes updating the one or more electronic description files after the smart device is put in service.

17. The method of claim 1, wherein the information about the smart device from the one or more electronic description files is stored as a series of nodes, each node corresponding to a particular aspect of the smart device.

18. The method of claim 1, wherein providing a smart device includes loading the smart device with the one or more electronic description files at the time of manufacture.
